(19) United States
(12) Patent Application Publication
(10) Pub. No.: US 2011/0304912 A1
(43) Pub. Date: Dec. 15, 2011

(54) MULTI-LAYER FILM DEPICTING A COLOUR TWO-DIMENSIONAL IMAGE WHICH IS ONLY VISIBLE THROUGH A POLARIZING FILTER AND PROCESS FOR MAKING THE FILM

(75) Inventors: Martin Eduardo Broen, Milano (IT); Emanuele Teobaldo, Castel Gandolfo (Roma) (IT); Enrico Girotti, Cesena ( Forli Cesena) (IT); Giacomo Melani, Milano (IT)

(73) Assignee: LUXOTTICA S.R.L., 32021 Agordo (IT)

(21) Appl. No.: 13/139,686

(22) PCT Filed: Dec. 23, 2009
(86) PCT No.: PCT/IB09/55937

§ 371 Date: Jul. 25, 2011

(30) Foreign Application Priority Data
Dec. 23, 2008 (IT) BO2008A000770

(51) Int. Cl. G02B 5/30; B32B 38/04; B44C 3/12

(52) U.S. Cl. 359/483.01; 156/63; 156/263; 156/517

(57) ABSTRACT

A multi-layer film (1), depicting a colour two-dimensional image which is only visible through a polarizing filter comprises an optically active layer (2) placed over a polarizing layer (3) and configured to form the image on its face opposite the polarizing layer (3) when said face is seen through the polarizing filter, the optically active layer (2) comprising a plurality of sheets (4) of optically active material placed over each other, at least one of which is shaped to form at least one portion of the outline of the image.

### TECHNICAL FIELD

This invention relates to a multi-layer film depicting a colour two-dimensional image which is only visible through a polarizing filter and a process for making the film.

In particular, the invention addresses the field of devices used for advertising or demonstration purposes and having optical properties such as to allow images to be viewed only through polarizing filters such as, for example, polarized sunglass lenses.

### BACKGROUND ART

In this field, labels and cards are known which are used for demonstration purposes in the sale of glasses with polarized lenses and which comprise multi-layer structures consisting of a polarizing layer with a transparent sheet bearing an image applied to it.

Owing to the polarizing layer behind the sheet bearing the image, the image is visible only through glasses with polarized lenses.

These solutions have the drawback of allowing images to be viewed only in black and white or shades of grey.

It should also be noted that an art form known as “polage” is used by American artist Austine Wood Comarow to create coloured images.

According to the polage technique, pieces of cellulose are cut and arranged in mosaic style to form a layer placed on a transparent surface. The rear face of the mosaic is irradiated with polarized light. A polarizing screen is rotated in front of the front face of the mosaic.

The effect obtained is that of a coloured image that changes over time according to the angle of rotation of the polarizing screen relative to the orientation of the polarized light.

The polage technique exploits the optical properties of cellulose, which is an optically active material.

Optically active materials are materials which, when crossed by a ray of polarized light, rotate the orientation of polarization of the light ray. The type of rotation depends on the nature and thickness of the specific material crossed by the ray. This optical property is also known as birefringence.

Polage, however, is a technique for creating images that change over time and is not concerned with creating devices that reproduce images (used for advertising purposes or of a promotional nature) which are visible only through polarizing screens.

Moreover, polage is an extremely complicated technique because the size of the cellulose pieces determines the resolution of the image obtained: the higher the resolution required for the image the smaller the pieces of cellulose must be cut.

Polage, therefore, which was developed as a form of art, would be inconvenient and unsuitable for adaptation to an industrial application.

### DISCLOSURE OF THE INVENTION

This invention has for an aim to provide a multi-layer film depicting a colour two-dimensional image which is only visible through a polarizing filter and a process for making the film, which overcome the above-mentioned disadvantages of the prior art.

In particular, this invention has for an aim to provide a film depicting a colour two-dimensional image which is only visible through a polarizing filter which has a particularly simple construction and at the same time depicts high resolution images.

Said film is a multi-layer film depicting a colour two-dimensional image which is only visible through a polarizing filter, having an optically active layer placed over a polarizing layer and configured to form said image on its face opposite the polarizing layer when said face is seen through the polarizing filter.

This invention also has for an aim to provide a process for making such a film depicting high resolution images in a particularly simple way, so that the process can be used at industrial level.

The process comprises the following steps:
preparing a polarizing layer;
preparing an optically active layer configured to form said image on one of its faces when said face is seen through the polarizing filter;
placing the optically active layer over the polarizing layer.

Yet another aim of the invention is to propose an apparatus for making such a film at industrial level.

Said aims are fulfilled by the film according to this invention, as described in the appended claims, in particular the film being characterised in that the optically active layer comprises a plurality of sheets of optically active material placed over each other, at least one of said sheets being shaped to form at least one portion of the outline of the image.

The process according to this invention is characterised in that preparation of the optically active layer comprises the following steps:
preparing a plurality of sheets of optically active material;
shaping at least one of said sheets to form at least one portion of the outline of the image;
placing the sheets over each other and stably joining them to form the optically active layer.

### BRIEF DESCRIPTION OF THE DRAWINGS

These and other features of the invention will become more apparent from the following detailed description of a preferred, non-limiting example embodiment of it, with reference to the accompanying drawings, in which:

FIG. 1 illustrates a film made according to the invention, with reference to some steps of the process for making the film;

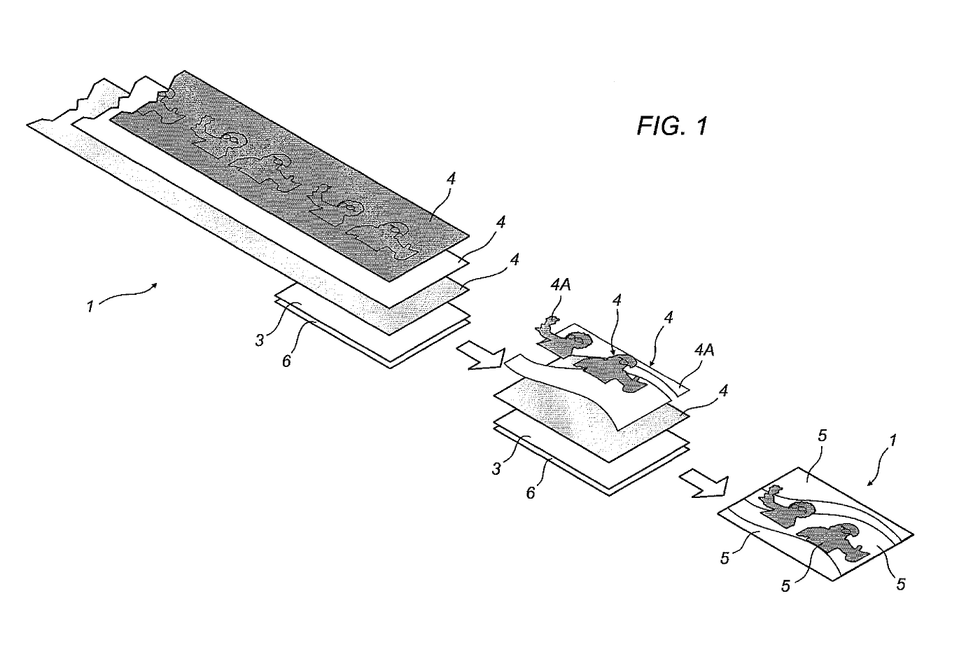

FIG. 2 illustrates the film of FIG. 1, with reference to additional steps of the process for making the film;

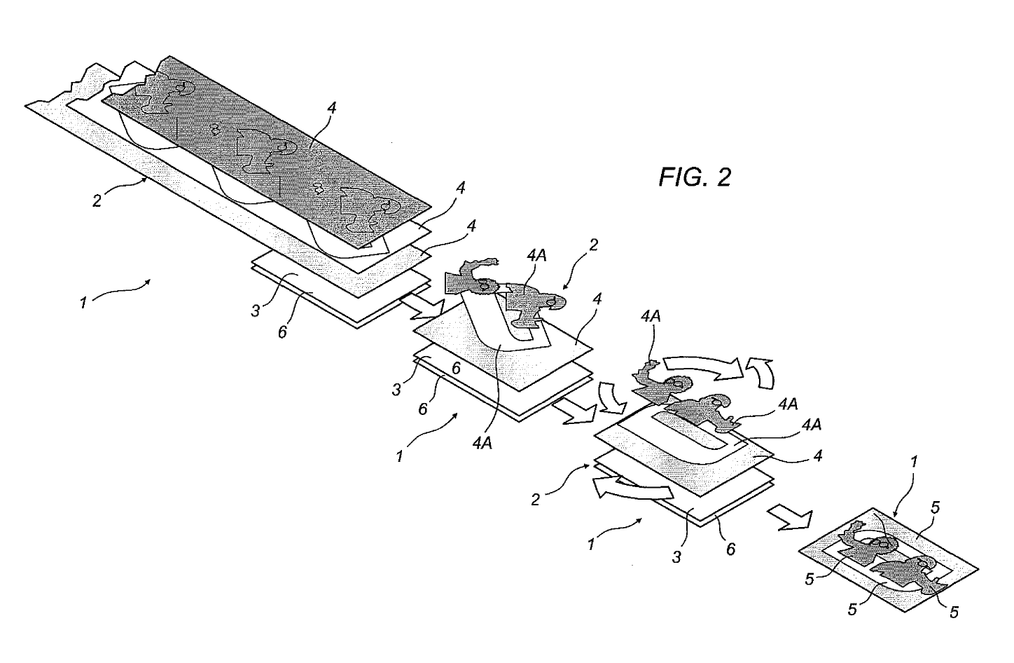

FIG. 3 illustrates an apparatus made according to the invention for making the film of FIG. 1.

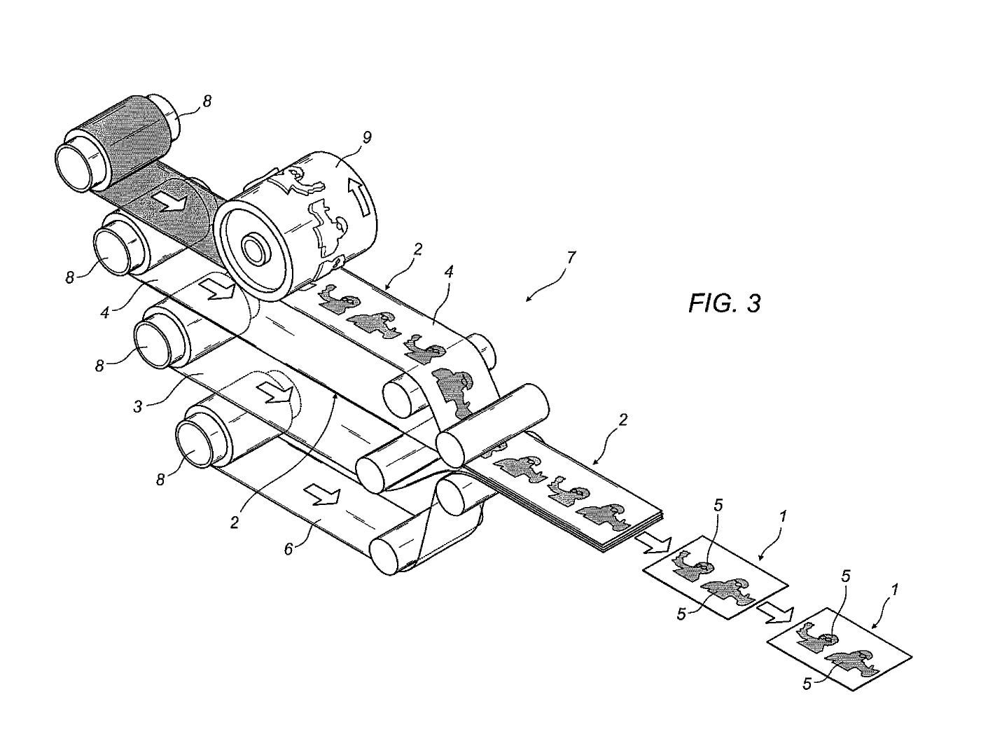

### DETAILED DESCRIPTION OF THE PREFERRED EMBODIMENTS OF THE INVENTION

The numeral 1 in the drawings denotes a film according to the invention.

The film 1 is a multi-layer film depicting a colour two-dimensional image which is only visible through a polarizing filter.

The film 1 comprises an optically active layer 2, that is to say, a layer which, when crossed by a ray of polarized light, rotates the orientation of polarization of the light ray coming out of the layer.

The film 1 also comprises a polarizing layer 3 (of the known type).

The optically active layer 2 is placed over the polarizing layer 3. In particular, a rear face of the optically active layer 2 is in contact with the polarizing layer 3.

The optically active layer 2 is configured to form the desired image on its front face which is opposite the polarizing layer. Said image is displayed on the front face of the optically active layer 2 when that face is seen through a polarizing filter.

The optically active layer 2 is configured in such a way that it has different optical properties depending on the zones of the layer 2. In that way, the rays of light which cross the optically active layer 2 are subjected to rotations of the orientation of the respective polarizations depending on the zone of the optically active layer 2 they cross. Such rotations in the orientation of the polarizations of the various rays of light cannot be seen with the naked eye, therefore the image is invisible (that is to say, encrypted).

In contrast, when a polarizing filter is interposed between the eyes of the observer and the optically active layer 2, of the rays crossing the polarizing filter 2, only those whose orientation of polarization is the same as that of the filter are transmitted, whilst the others are stopped by the filter. That causes the image to be seen.

Therefore, the polarizing filter forms means for decrypting the image created in an encrypted form on the front face of the optically active layer 2.

Therefore, the optically active layer 2 is configured to form the image on its face opposite the polarizing layer 3 when said face is seen through the polarizing filter.

According to the invention, the optically active layer 2 comprises a plurality of sheets 4 of optically active material placed over each other.

The plastic material of which the film is made (for example PET) may have various degrees of stiffness. The plastic material of which the film is made may be particularly flexible (for example with thicknesses of around 1 mm for the optically active layer 2) or it may be substantially stiff (for example with thicknesses of more than 5 mm for the optically active layer 2). In the latter case, the film consists of a rigid plate. However, according to the preferred embodiment of the film 1, the optically active layer 2 is thin and flexible.

At least one of the sheets 4 is shaped to form at least one portion of the outline of the image. In particular, the optically active layer 2 comprises a plurality of areas 5 positioned side by side relative to the surface of the polarizing layer 3, that is to say, side by side on the front face (opposite the polarizing layer 3) of the optically active layer 2, forming corresponding portions of the image.

The meaning of the expression “side by side areas 5” should be explained.

The optically active layer 2 has a surface of extension (forming the front face of the layer) and a thickness, understood to be the layer dimension perpendicular to the surface of extension. The areas 5 are positioned side by side in the sense that they are placed on the surface of extension of the layer 2. Therefore, each area 5 is spaced relative to the others along the surface of extension. Moreover, each area 5 has a thickness equal to the thickness of the layer 2 in that area 5. It should also be noticed that this invention does not require any type of action for “placing side by side” portions of the layer 2 to form the areas 5. The areas 5 are formed by placing a plurality of sheets 4 over each other. The sheets are layered to form the layer 2. The sheets 4 are suitably shaped, so that when they are placed over each other areas 5 are formed. Therefore, the layer 2 is not in any way made up of a mosaic of portions which are connected by drawing them near each other (or “placing side by side”) along the surface of extension.

Each area 5 comprises a predetermined number of corresponding portions 4A of sheets 4 placed over each other. In that way, each portion of the image (corresponding to a respective area 5) has a predetermined colour when seen through the polarizing filter.

By placing a different number of sheets 4 over each other in each area, an optically active layer 2 is obtained in which the areas 5 have different thicknesses.

With regard to this, it should be noticed that the optical properties (of birefringence) of an optically active material vary with the thickness of the material crossed by the rays of light.

In light of this, it should also be noticed that, according to the invention, the sheets 4 must have different thicknesses. Said sheet thickness values are selected according to the optical properties wanted for the optically active layer 2, that is to say, according to the colours to be assigned to the various portions of the image.

The sheets 4 of optically active material form respective preferred directions of optical activity, being designed to rotate the orientation of a polarized ray of light crossing them, according to an orientation of the preferred directions of optical activity.

Preferably, at least one of the sheets 4 comprises (even more preferably all of the sheets 4 comprise) a sheet of plastic material which is mechanically stressed along a preferred direction (corresponding to the preferred direction of optical activity).

Alternatively, the sheets 4 may also be sheets of cellulose.

According to another aspect of the invention, at least one of the portions 4A of sheets 4 placed over each other is rotated relative to a corresponding portion 4A of another sheet 4 placed over it in the same area 5, in such a way that the respective preferred directions of optical activity of said portions are rotated relative to each other through a predetermined angle.

With regard to this, it should be noticed that the effect of rotating the orientation of polarization of a ray of light performed by a sheet 4 of optically active material depends not just on the thickness of the sheet 4, but also on the angle formed between the preferred direction of optical activity of the optically active material (used to make the sheet 4) and the orientation of polarization of the incident ray.

Moreover, the film 1 comprises an adhesive layer 6 applied to a rear face of the polarizing layer 3 opposite the optically active element 2, to allow the film 1 to be applied to a transparent support constituting a transparency. The adhesive layer 6 is preferably a sheet of electrostatic (electrostatically charged) material, designed to allow the film 1 to adhere to the surface of a piece of glass.

As an alternative to the adhesive layer, it is possible to apply to the rear of the polarizing layer 3 a reflective screen or a light emitter, depending on the film application.

This invention also provides a reel comprising a film 1 according to any of the foregoing claims, wherein the optically active layer 2 is configured in such a way as to form a plurality of images side by side along a direction of extension of the film 1, the film 1 being wound about an axis perpendicular to said direction of extension to form the reel.

Advantageously, this allows large quantities of film to be made available, which are easy to transport and store, for the large-scale production of transparencies.

This invention also provides a process for making a multi-layer film 1 depicting a colour two-dimensional image (or a plurality of images) which is only visible through a polarizing filter.

The process comprises the following steps:
preparing the polarizing layer 3;
preparing the optically active layer 2 configured to form the image on its front face when said face is seen through the polarizing filter;
placing the optically active layer 2 over the polarizing layer 3.

According to the invention, preparation of the optically active layer 2 comprises the following steps:
preparing a plurality of sheets 4 of optically active material;
shaping at least one of the sheets 4 to form at least one portion of the outline of the image;
placing the sheets 4 (or shaped portions 4A of them) over each other and stably joining them to form the optically active layer 2.

Shaping is preferably carried out by punching. Alternatively, shaping comprises cutting using a plotter.

A plurality of sheets 4 is preferably shaped, to advantageously obtain complex images with particularly high resolution.

The sheets 4 or portions 4A of them are preferably joined by gluing.

It should be noticed that the steps of shaping the sheets (or shaped portions 4A of them) and placing them over each other are carried out in such a way as to form in the optically active layer 2 a plurality of areas 5 positioned side by side to form corresponding portions of the image.

Each area 5 comprises a predetermined number of corresponding portions 4A of sheets placed over each other. Consequently, the portion of the image corresponding to a respective area 5 of the optically active layer 2 has a predetermined colour when seen through the polarizing filter.

Preferably (but not necessarily), the step of preparing the sheets 4 comprises a rotation of at least one of the portions 4A of sheet 4 relative to a corresponding portion 4A of another sheet 4 placed over it in the same area 5, in such a way that the respective preferred directions of optical activity of said portions 4A are rotated relative to each other through a predetermined angle.

According to the invention, the desired predetermined colour of the different portions of the image (corresponding to respective areas 5 of the optically active layer 2) is checked during the steps of the process, based on the following process parameters:
the number of sheets 4 or portions 4A of them placed over each other at the same area 5;
the type of optically active material used to make the sheets 4;
the thickness of each of the sheets 4 (advantageously, sheets 4 having different thicknesses are used);
the angle through which a portion 4A of a sheet 4 is rotated relative to the sheets 4 (or to corresponding portions 4 of them) placed over it in the same area 5 of the optically active layer 2.

Such process parameters can all be controlled (in combination with each other). However, to obtain colour images according to the invention it is sufficient to act on the number of sheets 4 (or portions 4A of them) placed over each other at the same area 5.

According to another aspect of this invention, the optically active layer 2 is prepared so that it forms a plurality of images side by side along a direction of extension of the film.

Advantageously, this allows the production of a very long film.

In light of this, there is a step of cutting the film 1 along cutting planes which are perpendicular to the direction of extension of the film, to obtain a plurality of segments of film 1, in a continuous process.

Alternatively to the cutting step, the process comprises a step of winding the film 1 about an axis which is perpendicular to the direction of extension to form a reel (from which it is possible to obtain segments of film corresponding to the desired images, at any time as required).

Therefore, the process according to the invention is particularly suited to the industrial level production of film 1 (in the form of segments or reels). The process described above is fully automated and continuous.

This invention also provides an apparatus 7 for making the film 1; that is to say, for making a multi-layer film depicting a colour two-dimensional image which is only visible through polarizing filters.

The apparatus 7 comprises:
a feeder for feeding sheets 4 of optically active material to a shaping station;
means for shaping at least one of the sheets 4 (preferably a plurality of sheets 4) to form at least one portion of the outline of the image;
means for placing a polarizing layer 3 in a gluing station;
a gluer (not illustrated in the drawings, of the known type) operating on the sheets 4 for applying them one on top of another to form the optically active layer 2.

The gluer also operates on the optically active layer 2 for applying it to the polarizing layer 3 (and if necessary also for applying the polarizing layer 3 to the adhesive layer 6) in the gluing station.

The feeder for feeding sheets 4 to the shaping station preferably comprises a plurality of feed rollers 8.

The means for shaping the sheets 4 preferably comprise a punching module. More preferably, the means for shaping the sheets 4 comprise a punching roller 9.

The means for positioning the polarizing layer 3 (and the adhesive layer 6) in the gluing station, together with the sheets 4, preferably comprise a plurality of conveyor rollers 10, positioned so as to bring the layers 3 and 6 and the sheets 4 towards each other, placing them one on top of another.

The gluer preferably comprises a plurality of adhesive liquid dispensers (not illustrated), configured to place a thin layer of adhesive liquid on an outer surface of the conveyor rollers 10.

For gluing the various layers of film 1 together, adhesive or double-sided adhesive films may be used, or electrostatic films.

The film according to this invention has many applications, including in particular those indicated below.

A first application is the transparency, that is to say, application of the film on a transparent support (for example a piece of glass).

Another application is a glasses case, made using the film according to the invention and bearing encrypted images and text.

Another application is a mirror comprising the film made according to this invention which is applied to a frame or in any case coupled to the mirror so that a person looking in the mirror while wearing glasses having polarized lenses can see the images and texts on the film, realising that they would be invisible if he or she were not wearing the glasses.

Another application is a lamp with the film according to this invention applied to the lampshade, so that the light from the lamp passes through it. In that way, the encrypted images in the film are highlighted when the lamp is switched on, creating a very pleasant effect and without limiting the effectiveness of illumination by the lamp.

Another application is a rigid support with a light source positioned behind the film applied to the support, for forming a picture or advertising poster or illuminated sign.

The invention offers the following advantages.

The film 1 bears encrypted colour images which are only visible through polarizing filters, the filters consisting for example of glasses with special polarized lenses.

Therefore, the film 1 is particularly suitable for making a transparency, especially for advertising purposes for selling such glasses.

Its construction being particularly simple, the film 1 allows use on a vast scale.

Despite its simple construction, thanks to the original placing of optically active portions over each other, the film 1 allows a particular quality and resolution of the encrypted images formed by the film.

The process for making the film is simple and effective and is fully automated. Therefore, it can be used at industrial level, in a continuous process. It allows the production of high quality films (in terms of the optical properties of the film and the resolution of the images) and high resolution with particularly low production costs.

The costs are lowered mainly thanks to the innovative process of placing two or more layers over each other and using materials which have been mechanically pre-stressed.

1. A multi-layer film (1) depicting a coloured two-dimensional image which is only visible through a polarizing filter, having an optically active layer (2) placed over a polarizing layer (3) and configured to form said image on its face opposite the polarizing layer (3) when said face is seen through the polarizing filter, wherein the optically active layer (2) comprises a plurality of sheets (4) of optically active material placed over each other, at least one of said sheets (4) being shaped to form at least one portion of the outline of the image,
characterised in that said polarizing layer (3) and said optically active layer (2) are transparent, to allow light to pass through the multi-layer film (1).

2. The film according to claim 1, wherein the optically active layer (2) comprises a plurality of areas (5) positioned side by side in said face opposite the polarizing layer (3), forming corresponding portions of the image, each area (5) comprising a predetermined number of corresponding portions (4A) of sheets (4) placed over each other, so that said portion (5) of the image has a predetermined colour when seen through the polarizing filter.

3. The film according to claim 2, wherein the sheets (4) of optically active material form respective preferred directions of optical activity, being designed to rotate the orientation of a polarised ray of light passing through them, according to an orientation of the preferred directions of optical activity.

4. The film according to claim 3, wherein at least one of the portions (4A) of sheets (4) placed over each other is rotated relative to a corresponding portion (4A) of another sheet (4) placed over it in the same area (5), in such a way that the respective preferred directions of optical activity of said portions (4A) are rotated relative to each other through a predetermined angle.

5. The film according to claim 3, wherein at least one of the sheets (4A) comprises a sheet of plastic material which is mechanically stressed along the preferred direction.

6. The film according to claim 1, comprising an adhesive layer (6) applied to a face of the polarizing layer (3) opposite the optically active layer (2), for applying the film (1) to a transparent support constituting a transparency.

7. A reel comprising a film according to claim 1, wherein the optically active layer (2) is configured in such a way as to form a plurality of images side by side along a direction of extension of the film (1), the film (1) being wound about an axis perpendicular to said direction of extension to form the reel.

8. A process for making a multi-layer film (1) depicting a colour two-dimensional image which is only visible through a polarizing filter, characterised in that it comprises the following steps:
preparing a polarizing layer (3), said polarizing layer (3) being transparent, to allow light to pass through the multi-layer film (1);
preparing an optically active layer (2) configured to form said image on one of its faces when said face is seen through the polarizing filter, said optically active layer (2) being transparent, to allow light to pass through the multi-layer film (1);
placing the optically active layer (2) over the polarizing layer (3);
preparing a plurality of sheets (4) of optically active material;
shaping at least one of said sheets (4) to form at least one portion of the outline of the image;
placing the sheets (4) over each other and stably joining them to form the optically active layer (2).

9. The process according to claim 8, wherein the steps of shaping the sheets and placing them over each other are carried out in such a way that a plurality of areas (5) positioned side by side forming corresponding portions of the image are formed in the optically active layer (2), each area (5) comprising a predetermined number of corresponding portions (4A) of sheets (4) placed over each other, the corresponding portion of the image adopting a predetermined colour when seen through the polarizing filter.

10. The process according to claim 9, wherein the step of preparing the sheets (4) comprises rotating at least one of the portions (4A) of sheet (4) relative to a corresponding portion (4A) of another sheet (4) placed over it in the same area (5), in such a way that respective preferred directions of optical activity of said portions (4A) are rotated relative to each other through a predetermined angle.

11. The process according to claim 8, wherein the optically active layer (2) is prepared to form a plurality of images side by side along a direction of extension of the film (1), the process also comprising a step of winding the film (1) about an axis which is perpendicular to said direction of extension to form a reel.

12. An apparatus (7) for making a multi-layer film (1) depicting a colour two-dimensional image which is only visible through polarizing filters, comprising:
a feeder (8) for feeding sheets (4) of optically active material to a shaping station;
means (9) for shaping at least one of said sheets (4) to form at least one portion of the outline of the image;
means (10) for placing a polarizing layer (3) in a gluing station;
a gluer operating on the sheets (4) for applying them one on top of another, thus forming an optically active layer (2), and for applying the optically active layer (2) to the polarizing layer (3) in the gluing station.
